(19) United States
(12) Patent Application Publication
(10) Pub. No.: US 2007/0190285 A1
(43) Pub. Date: Aug. 16, 2007

(54) Method for making a combination structure with different materials and the combination structure

(76) Inventor: Wuu-Cheau Jou, Dali City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/352,838

(22) Filed: Feb. 13, 2006

(51) Int. Cl. B44C 1/26

(52) U.S. Cl. 428/67; 428/217

(57) ABSTRACT

A combination structure is composed of a hard body having a hollow interior, at least one recess defined in one side of the hard body, a soft material filling in the at least one recess and at least one bulge emerged from the hard body. By filling the soft material inside the hard body and forming the bulge, the soft material is protected by the hard body from torque deformation and provides the anti-slide efficiency. A method for making the combination structure is to hold the hard body within a mold and inject soft material into the mold, thereby, the combination structure is achieved.

### BACKGROUND OF THE INVENTION

1. Field of the Invention

The present invention relates to a method for making a combination structure having two different materials, and more particular to a method that makes the two different materials combine firmly. Configuration of the combination structure is also disclosed.

2. Description of Related Art

With reference to FIG. 11, a conventional tool handle 11 (also called “body” in the following description) is made of acetal copolymer plastic, nylon, acrylonitrile butadiene styrene (ABS), or polyester (PE) by injection molding or made of metal materials such as zinc, aluminum, or carbon steel. However, the materials described above for making the tool handle 11 are rigid and slippery so that the handle 11 can not be gripped stably.

With reference to FIG. 12, an improved conventional combination handle is composed of a body 12 and a soft rubber of thermo plastic elastomer surrounding the body 12 to perform a soft layer 13 that provides gentle touch and nice damping efficiency for stable grip. However, the soft TPR only provides an excellent affinity to the nylon plastic. Other materials, even more the metals, can not be applied with the TPR. Additionally, the body 12 of hard nylon must have several through holes 121 defined to allow the soft rubber passing through to become connecting bridges 14. Therefore, strength of the combination handle is improved because the soft layers 13 at two sides are connected by the connecting bridges 14 and do not easily separate with the body 12 under torque.

Although this improved combination handle has excellent strength in combining two different materials, the hard body 12 is limited in nylon without wide adoption and manufacturing cost of the handle is high. Moreover, the hard body 12 must have multiple through holes 121 to enhance the combination strength of the hard body 12 and the soft rubber. This configuration of the hard body 12 only can be applied to some certain handles such as a screw driver or a wrench having no accessory inside but not to complex handles such as a pneumatic tool, an electric tool or a dust-blowing gun having channels with accessory.

### SUMMARY OF THE INVENTION

According to above description, a modified combination structure of handle is provided to overcome the drawbacks of the conventional handle structure having two different materials.

A main objective of the present invention is to provide combination structure that combines two different materials to perform a durable handle.

To achieve the foregoing main objective, the combination structure comprises a hard body having a hollow interior, at least one recess defined in one side of the hard body, a soft material filling in the at least one recess and at least one bulge emerged from the hard body. By filling the soft material inside the hard body and forming the bulge, the soft material is protected by the hard body from torque deformation and provides the anti-slide efficiency.

Another main objective of the present invention is to provide a method that manufactures the combination structure with two different materials as described above.

To achieve the foregoing main objective, the method is to hold the hard body in a mold and then inject the soft material into the at least one recess to fill the hard body or even to entirely or partially surround the hard body. By filling the soft material within the hard body and embracing at least one side of the hard body by the bulge, the combination structure has excellent strength even the hard body and the soft material have poor affinity. Therefore, material of the hard body is not limited anymore.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hard body of a combination structure in accordance with the present invention;

FIG. 2 is a cross-sectional side view of the hard body in FIG. 1;

FIG. 3 is an operational cross-sectional side view showing that the hard body is held in a mold;

FIG. 4 is an operational cross-sectional side view showing that a soft material is injected into the mold and the hard body as shown in FIG. 3;

FIG. 5 is perspective view of the combination structure after injecting the soft material into the hard body;

FIG. 6 is a cross-sectional side view of another embodiment of the combination structure, wherein the hard body has four recesses at four sides;

FIG. 7 is an operational cross-sectional side view showing that the soft material is injected into the mold and the hard body as shown in FIG. 6;

FIG. 8 is a cross-sectional side view of still another embodiment of the combination structure, wherein the hard body has a gap defined between at three sides of the hard body and an inner wall of the mold;

FIG. 9 is an operational cross-sectional side view showing that the soft material is injected into the mold and the hard body as shown in FIG. 8 to form a continuous side brace;

FIG. 10 is a cross-sectional side view of further another embodiment of the combination structure, wherein the hard body has a gap defined between entire periphery of the hard body and the inner wall of the mold;

FIG. 11 is a perspective view of a conventional tool handle made of hard material in accordance with the prior art; and

FIG. 12 is a cross-sectional side view of another conventional tool handle made of two plastic materials in accordance with the prior art.

### DETAILED DESCRIPTION OF THE PREFERRED EMBODIMENT

A combination structure in accordance with the present invention comprises a hard body having a hollow interior, at least one recess defined in one side of the hard body, a soft material filling in the at least one recess and at least one bulge emerged from the hard body. By filling the soft material inside the hard body and forming the bulge, the soft material is protected by the hard body from torque deformation and provides the anti-slide efficiency. A method for making the combination structure is to hold the hard body within a mold and then inject soft material into the mold, thereby, the combination structure is achieved.

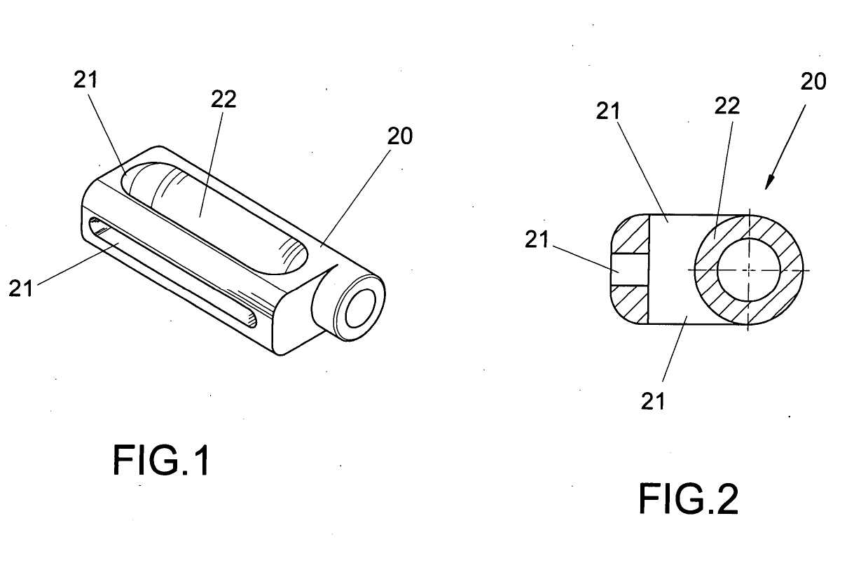

With reference to FIGS. 1 and 2, the different material combination of the present invention includes a hard body 20 that has a hollow interior and three recesses 21 defined three sides of the hard body 20, wherein the three recesses 21 are communicated with each other. The hard body 20 has an inner body 22 integrally combined with the hard body 20, wherein the inner body 22 is hollow to allow having accommodation of accessory or flow of fluids.

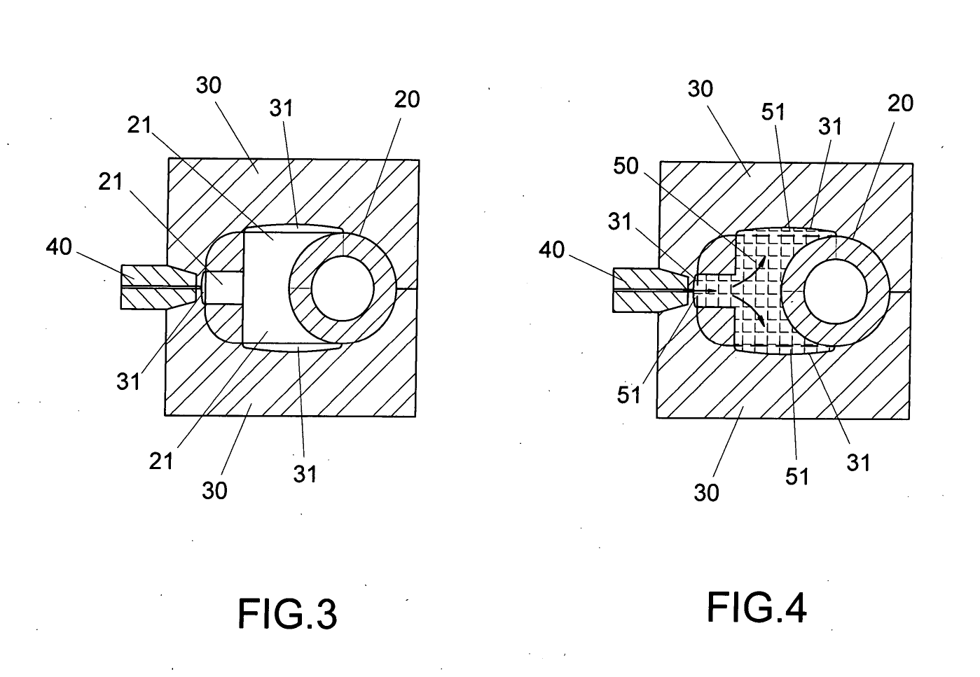

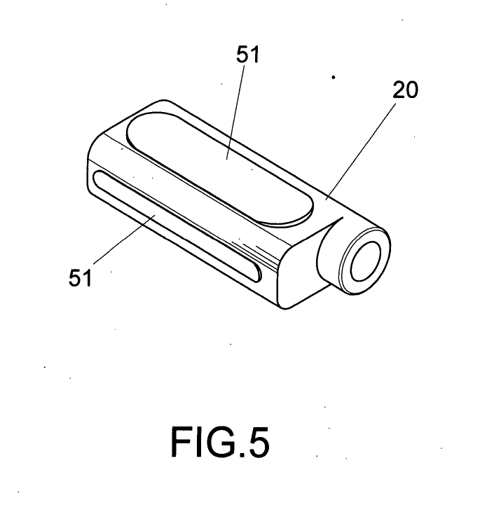

With reference to FIGS. 3 and 4, the method for making the different material combination is to hold the hard body 20 inside a mold 30 to make two recesses 21 to align with two cavities 31 inside the mold 30 and the rest one recess 21 to align with an injection nozzle 40. Soft material 50 is liquid at initial and injected into the mold 30 via the injection nozzle 40 until it fills whole interior of the hard body 20 and becomes solid to achieve the combination structure of a handle as shown in FIG. 5. Lastly, the combination structure of the hard body 20 and the soft material 50 is taken out of the mold 30. Wherein, the soft material 50 filling at the cavities 31 performs bulges 51 for gripping convenience.

With reference to FIGS. 4 and 5, the achieved combination structure is made by filling the soft material 50 into the recesses of the hard body 20 and has the bulges 51 by shaping with the mold 30. The hollow inner body 22 is not filled with the soft material 50 and still enables to accommodate accessory. The majority of the soft material 50 is protected by the hard body 20 so that the combination structure has an excellent strength, anti-shearing efficiency and durability under torque.

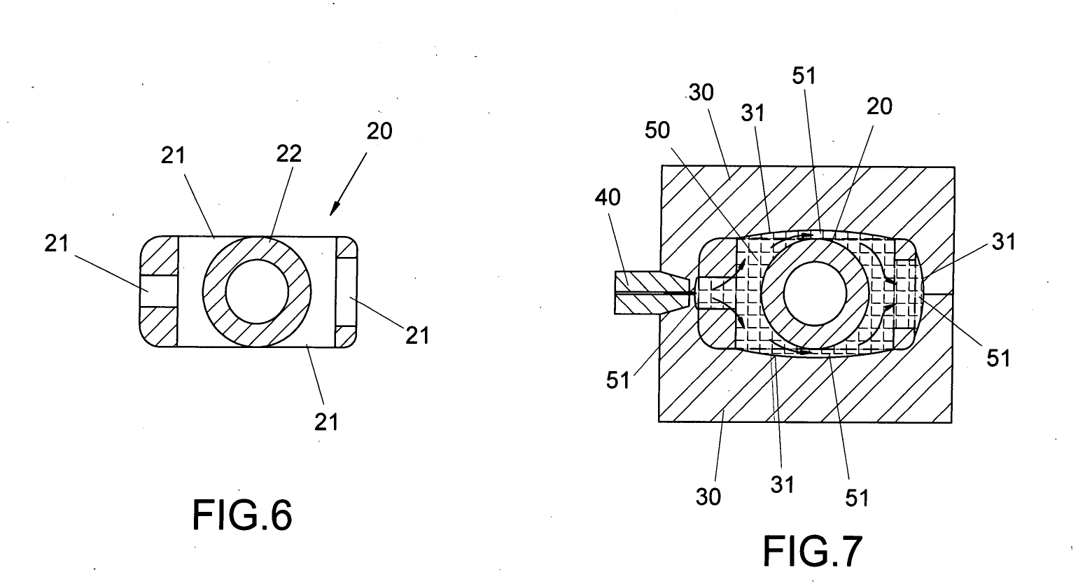

With reference to FIGS. 6 and 7, another preferred embodiment of the combination structure is similar with the one shown in FIGS. 3 and 4 except the hard body 20 has four recesses 21 at four sides. As shown in FIG. 7, the hard body 20 is held by the mold 30 to make the four recesses 21 align with corresponding four cavities 31. The soft material 50 is injected into the mold 30 via the injection nozzle 40 until the soft material 50 completely fills the mold 30. Therefore, four bulges 51 are formed at four sides of the combination structure of the handle.

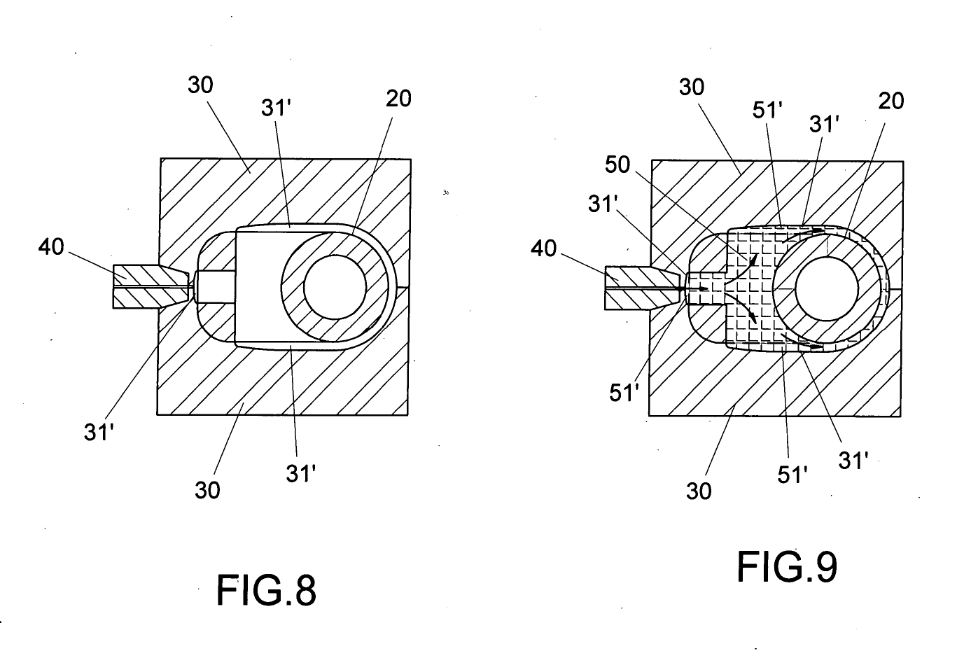

With reference to FIGS. 8 and 9, further another preferred 11 embodiment of the combination structure is similar with the one shown in FIGS. 3 and 4 except the hard body 20 is embraced by the soft material 50 at three sides in form of a continuous bulge 51′. To achieve the continuous bulge 51′, the mold 30 provides a continuous gap 31′ between the three sides of the hard body 20 and the inner wall of the mold 30 so that the soft material 50 flows into the continuous gap 31′ to form the continuous bulge 51′ after injecting.

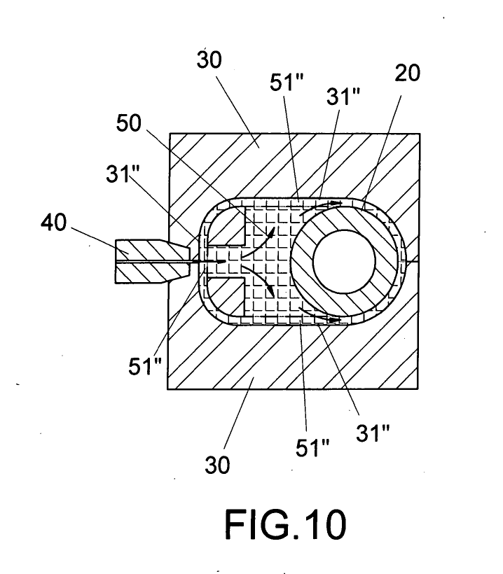

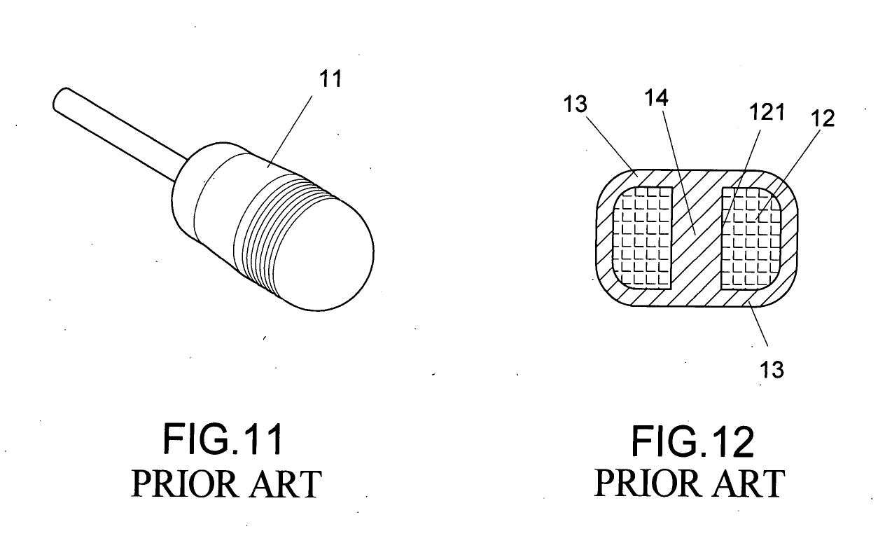

With reference to FIG. 10, still another preferred embodiment of the combination structure is similar with the one shown in FIG. 9 except the hard body 20 is surrounded by the soft material 50 at four sides in form of a continuous bulge 51″. To achieve the continuous bulge 51″, the mold 30 provides a continuous gap 31″ between the four sides of the hard body 20 and the inner wall of the mold 30 so that the soft material 50 flows into the continuous gap 31″ to form the continuous bulge 51″ after injecting.

According to above description, the combination structure is easily modified to selectively have bulges formed at one, two, three, four, partial periphery or entire periphery by simply changing the mold 30 with different cavities or gaps. Moreover, the soft material 50 is firmly combined with the hard body 20 by mostly filling inside the hard body 20 even the material the hard body 20 is not in affinity with the soft material 50 so that material variation of the combination structure is increased without limitation.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A method for making a combination structure with different materials, the method comprising:
providing a hard body with a hollow inner body and at least one recess defined in at least one side of the hard body;
holding the hard body within a mold, wherein the mold has at least one cavity correspondingly aligned with the at least one recess; and
injecting soft material in form of liquid into the mold until the soft material completely fills the at least one recess and the at least one cavity, wherein the soft material in the lat least one cavity performs at least one bulge after solidification.

2. The method as claimed in claim 1, wherein the mold has a continuous gap defined between three sides of the hard body and an inner wall of the mold.

3. The method as claimed in claim 1, wherein the mold has a continuous gap defined between four sides of the hard body and an inner wall of the mold.

4. A combination structure with two different materials comprising:
a hard body having at least one recess defined in at least one side of the hard body; and
a soft material filled inside the bard body and has a bulge emerged out of the hard body.

5. The combination structure as claimed in claim 4, wherein the hard body further has a hollow inner body in one-piece configuration.

6. The combination structure as claimed in claim 4, wherein the hard body has two recesses defined respectively at two sides of the hard body and communicated with each other.

7. The combination structure as claimed in claim 4, wherein the hard body has three recesses defined respectively at two sides of the hard body and each communicated one to the others.

8. The combination structure as claimed in claim 4, wherein the hard body has four recesses defined respectively at four sides of the hard body and each communicated one to the others.
